(19) United States
(12) Patent Application Publication
(10) Pub. No.: US 2025/0073698 A1
(43) Pub. Date: Mar. 6, 2025

(54) MULTICHANNEL PIPETTING HEAD

(71) Applicant: TECAN TRADING AG, Männedorf (CH)

(72) Inventor: Jan BEELI, Stäfa (CH)

(21) Appl. No.: 18/575,712

(22) PCT Filed: Oct. 18, 2023
(86) PCT No.: PCT/EP2023/079013

§ 371 Date: Dec. 29, 2023

(30) Foreign Application Priority Data
Oct. 21, 2022 (EP) 22202905.0

(51) Int. Cl. B01L 3/02

(52) U.S. Cl. CPC B01L 3/0217; B01L 2200/0689; B01L 2300/123

(57) ABSTRACT

The present invention resides in a multichannel head of a pipetting device for aspirating and dispensing liquid via a plurality of pipetting tips. The multichannel head comprises a connector block (110) having an array of m*n connectors (120), whereby each connector comprises an internal passageway (125) that is fluidically connectable to a pipetting tip, and further includes a plunger block having a corresponding array of m*n channels. Each channel accommodates a plunger and has an opening that is fluidically connected to the internal passageway (125) of a corresponding connector. The multichannel head further comprises a sealing mat (150) arranged between the connector block (110) and the plunger block, wherein the sealing mat comprises a corresponding array of men annular sealing elements for providing an airtight seal of the fluidic connection between the internal passageway of each connector and each opening of the corresponding plunger channel. The annular sealing elements are interconnected by a lattice of linkages that extend in lateral direction and in longitudinal direction, such that a cut-out region is formed between two opposing lateral linkages and two opposing longitudinal linkages. The sealing mat (150) is arranged on a receiving surface (116), which is provided with protrusions (117) that are shaped to pass through the cut-out regions of the sealing mat.

### FIELD OF THE INVENTION

The invention relates to a multichannel head of a pipetting device and is more particularly directed to a sealing arrangement for providing an airtight connection between openings in a plunger block of the multichannel head and connectors which provide a fluid space between a plunger and a pipetting tip that is attachable to a connector.

### BACKGROUND ART

Multichannel pipetting heads are well known in the art. An example of a 96-channel device is disclosed in U.S. Pat. No. 10,821,434. The device comprises a plurality of pistons in respective cylinders configured to simultaneously aspirate liquid into a plurality of pipetting tips. The device is further equipped with a tip adapter assembly for attachment of the tips. The adapter assembly comprises a seal compression plate into which adapter receiving ports are built. To provide an airtight connection, 96 O-rings are arranged coaxially with the piston cylinders and the adapter receiving ports, to which the pipetting tips are attached. The O-rings must be individually mounted during assembly of the device, which is rather time-consuming.

Assembly time can be reduced via the use of a sealing gasket comprising multiple apertures. The use of such a gasket is disclosed in U.S. Pat. No. 6,244,119, which describes a multichannel pipette system including a multichannel pipettor and novel pipette tips having a crown that can be fitted over the opening of more than one channel. The pipettor comprises channel support plates and a tip seal gasket arranged between the crown of a pipette and the channel support plate. The tip seal gasket may be formed from a sheet of elastomeric material.

In a multichannel pipetting head comprising a plunger block and a connector block for the attachment of e.g. 96 pipetting tips, the arrangement of such a sheet between the plunger block and the connector block for providing an airtight seal between their respective openings would require excessively large clamping forces.

It is also known to use O-ring sheets in sealing assemblies. For example, US2010080733 and corresponding application US2003116497 disclose a crystallization assembly comprising a reactor having first and second sides and a plurality of through-holes, whereby each through-hole includes a well located on the second side. An O-ring is accommodated in each well, such that the assembly comprises a plurality of O-rings, which may be formed by an O-ring sheet. The assembly further comprises a substrate, which provides a surface for crystal formation and which may be made of an optically transmissive material such as glass. The substrate is secured to the second side of the reactor with a base cover, which presses the substrate against each O-ring, to provide effective isolation of material samples that are deposited into the assembly via the through-holes, and thereby prevent cross-contamination.

In a multichannel pipetting head, the fluid space that is created via interconnected openings must be absolutely airtight, or pipetting will not work. It is furthermore important that robust and stable connection interfaces are formed between components of the multichannel head that comprise the interconnected openings. Consequently, there is still room for improvement.

### SUMMARY OF THE INVENTION

The present invention resides in a multichannel head of a pipetting device for aspirating and dispensing liquid via a plurality of pipetting tips. The multichannel head comprises a connector block having an array of m*n connectors, whereby each connector comprises an internal passageway that is fluidically connectable to a pipetting tip, and further includes a plunger block having a corresponding array of m*n channels. Each channel accommodates a plunger and has an opening that is fluidically connected to the internal passageway of a corresponding connector.

In accordance with the invention, the multichannel head further comprises at least one sealing mat arranged between the connector block and the plunger block, wherein the at least one sealing mat comprises a corresponding array of m*n annular sealing elements made of an elastomeric material, for providing an airtight seal of the fluidic connection between the internal passageway of each connector and each opening of the corresponding plunger channel. The annular sealing elements are interconnected by a lattice of linkages that extend in lateral direction and in longitudinal direction, such that a cut-out region is formed between two opposing lateral linkages and two opposing longitudinal linkages.

The at least one sealing mat is arranged on a corresponding at least one receiving surface, which surface comprises protrusions that are shaped to fit through the cut-out regions of the sealing mat, such that recessed portions are created in the receiving surface which locate the sealing mat. The annular sealing elements of the mat are arranged coaxially with the internal passageway of each connector and with the corresponding opening in the plunger block, and are compressed when the at least one sealing mat is clamped between the receiving surface and an opposing surface.

Suitably, the protrusions have a flat surface which, in assembled condition, bear against flat portions of the opposing surface. The protrusions therefore not only serve to locate the sealing mat, but also provide a relatively large contact area between the receiving surface and the opposing surface, which improves stability of the assembled multichannel head. The at least one receiving surface may be formed by an upper surface of the connector block, a lower surface of the plunger block or an upper or lower surface of an intermediate plate that is arranged between the connector block and the plunger block, as will be explained further below.

In one embodiment, the sealing mat has a uniform thickness and is formed of a single piece. Suitable materials include EPDM rubber and vulcanised thermoplastic elastomers. The cut-out regions of the interconnecting lattice reduce the surface area of the sealing mat that is compressed between the receiving surface and the opposing surface and thereby reduces the required clamping forces.

In a further development, the at least one receiving surface on which the at least one sealing mat of uniform thickness is arranged comprises first recessed portions for accommodating the annular sealing elements of the mat and second recessed portions for accommodating the linkages of the interconnecting lattice, whereby the second recessed portions are relatively deeper than the first. This has the advantage of further reducing the required clamping forces.

In a further embodiment, the annular sealing elements have a thickness that is greater than that of the interconnecting lattice. Only the annular sealing elements are compressed between the opposing surfaces in order to provide an airtight connection, which again reduces the required clamping forces. Advantageously, the interconnecting lattice may be formed from a second material of greater stiffness than the elastomeric material of the annular sealing elements. In one example, the interconnecting lattice is formed from a polymer material that is moulded to the annular sealing elements. Suitable elastomeric materials for the sealing elements include EPDM rubber and vulcanised thermoplastic elastomers (TPE-V) such as dynamically vulcanised EPDM and polypropylene blends. The interconnecting lattice may be made from the same material or from polyethylene, polypropylene or other suitable material. In some examples, where a relatively high stiffness is desirable for the interconnecting lattice, the second material may comprise thin metal inlays.

In an embodiment, the multichannel head comprises 96 channels and an array of 12*8 plungers and connectors. The at least one sealing mat then comprises an array of 12*8 annular sealing elements with a centre-to-centre distance of 9.0 mm. In a further embodiment, the multichannel head comprises 384 channels and array of 24*16 plungers and connectors. The at least one sealing mat then comprises an array of 24*16 annular sealing elements with a centre-to-centre distance of 4.5 mm. In a further embodiment, the multichannel head comprises 1536 channels and array of 48*32 plungers and connectors. The at least one sealing mat then comprises an array of 48*32 annular sealing elements with a centre-to-centre distance of 2.25 mm. In a still further embodiment, the multichannel head comprises 24 channels and an array of 6*4 plungers and connectors. The at least one sealing mat then comprises an array of 6*4 annular sealing elements with a centre-to-centre distance of 18.0 mm.

The number of channels of the multichannel head depends on the type of microplate that is used in the pipetting process, i.e. a 96-well, a 284-well, a 1536-well or a 24-well microplate. The wells have specific centre-to-centre distances, which correspond to the centre-to-centre distances mentioned above, and which are defined for the various types of microplate in the standard “ANSI SLAS 4-2004 (R2012), For microplates-Well positions”, the contents of which are incorporated by reference.

Suitably, the m*n plungers of the plunger block are connected to a piston plate of the multichannel head, which is displaced in vertical direction so as to displace the plungers for generating a negative pressure or a positive pressure. The piston plate may be mounted to a linear displacement mechanism such as arrangement of spindles which are driven by a motor and e.g. a belt and pulley arrangement.

The connector block may comprise a connector plate having an upper surface that is sealed against an opposing surface. In some examples, the connector plate has an array of apertures for supporting connectors. A first end of each connector may have a collar that rests on the upper surface of the connector plate, whereby a main body of the connector extends through the aperture. A second end of the connector is adapted for attachment of a pipetting tip and is suitably provided with a seat for a ring seal that engages with the internal diameter of a pipetting tip. In other examples, the apertures in the connector plate are provided with a screw thread and the first end of each connector has a corresponding thread.

In further examples, the connecting plate has apertures which form a bore for the direct attachment of pipetting tips which are provided with connection features such as guiding ribs and sealing rings arranged on an outer diameter of the tip. The bore of each aperture then constitutes the “connector” of the connector block having an internal passageway in fluid communication with an attached pipetting tip.

In the aforementioned examples, the connector block of the multichannel head is configured to pick up an array of pipetting tips via engagement between the connector and an internal or external diameter of an individual pipetting tip. It is also possible for the underside of the connection plate to be adapted to pick up an array of pipetting tips which are held in a block. The connectors then engage with fluid channels in the block.

In an embodiment of the invention, the connector block is mounted directly to the plunger block, e.g. via a bolted connection, and comprises one sealing mat as described above.

In one example, the sealing mat is provided on the upper surface of the connector plate. The upper surface forms the receiving surface and is suitably milled so as to comprise protrusions and recessed portions as described above. Preferably, the protrusions have the same shape as the cut-out regions of the sealing mat so as to precisely locate the sealing mat during assembly. In assembled condition, the annular sealing elements are compressed against the underside of the plunger block, which may be a flat surface. The cut-out regions also serve to increase the contact surface area between the underside of the plunger block and a flat upper surface of the protrusions, in assembled condition, which is advantageous in terms of improving stability.

Alternatively, the sealing mat may be provided on the underside of the plunger block, which, in the manner described above, is milled so as to comprise protrusions that pass through the cut-out regions of the sealing mat. The upper surface of the connector plate may then be a flat surface.

In a further embodiment of a multichannel pipetting head according to the invention, the head is equipped with capacitive liquid level detection, so as to enable the aspiration and dispensing of precise amounts of liquid. The details of the detection system are not relevant for the present invention, except for a possible requirement that the connector block is electrically isolated from the plunger block. In such embodiments, the multichannel head is provided with an isolation plate made of an electrically non-conducting material that is arranged between the connector block and the plunger block.

The isolation plate comprises an array of m*n bores that are coaxial with each opening of the corresponding plunger channel and each internal passageway of the corresponding connector. Furthermore, the multichannel head is suitably provided with a first sealing mat arranged on a first receiving surface between the plunger block and an upper surface of the isolation plate and with a second sealing mat arranged on a second receiving surface between the connector block and a lower surface of the isolation plate.

In some examples, the isolation plate has flat surfaces and the underside of the plunger block has a milled surface with protrusions and recesses as described above for locating the first sealing mat and increasing the contact surface area between the plunger block and the isolation plate. The upper surface of the connector plate is milled in a corresponding fashion for locating the second sealing mat and increasing the contact surface area between the isolation plate and the connector plate. It is also possible for the upper surface of the isolation plate to comprise protrusions and recessed portions for locating the first sealing mat and/or for the underside of the isolation plate to comprise protrusions and recessed portions for locating the second sealing mat.

A multichannel pipetting head comprising a sealing mat in accordance with the invention significantly reduces assembly time and allows the pipetting head to be assembled with the application of “normal” clamping forces, as well as robust and stable connections between components of the multichannel head that comprise interconnected openings.

These and other aspects of the invention are apparent from and will be elucidated with reference to the embodiments described hereinafter and with reference to the accompanying drawings.

### BRIEF DESCRIPTION OF THE DRAWINGS

FIG. 1a is a cross-sectional view of an example of a multichannel pipetting head in accordance with the invention

FIG. 1b is cut perspective view of a connector block of the multichannel head depicted in FIG. 1a;

FIG. 1c is a cut perspective view of part of a sealing mat according to a first embodiment;

FIG. 1d is a perspective view of an underside of a plunger block of the multichannel head depicted in FIG. 1a;

FIG. 2 is a perspective view of an example of a sealing mat according to a second embodiment.

It should be noted that items which have the same reference numbers in different figures, have the same structural features and the same functions. Where the function and/or structure of such an item has been explained, there is no necessity for repeated explanation thereof in the detailed description.

### DETAILED DESCRIPTION OF EMBODIMENTS

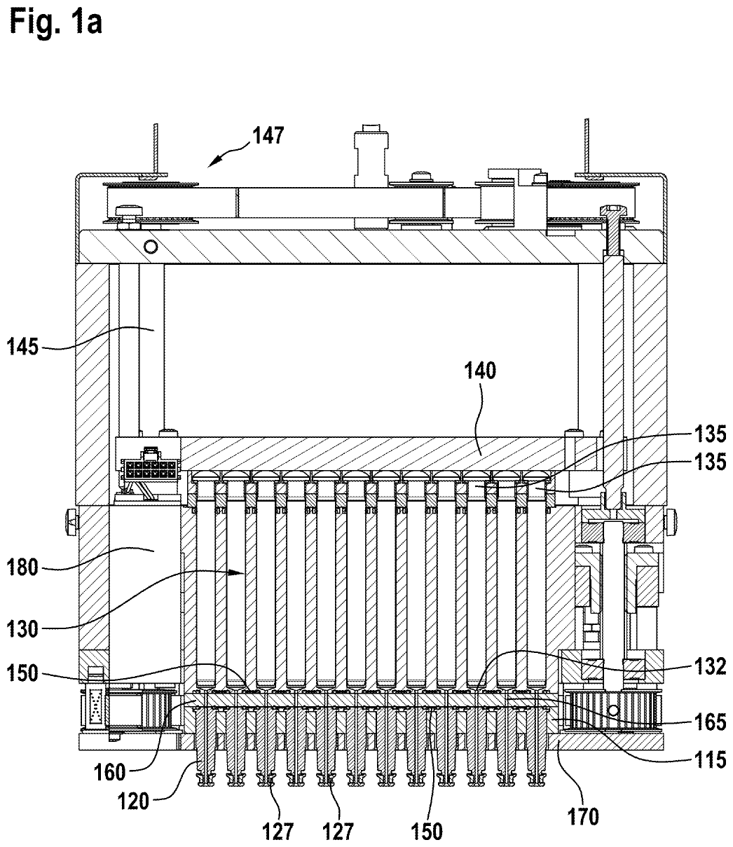

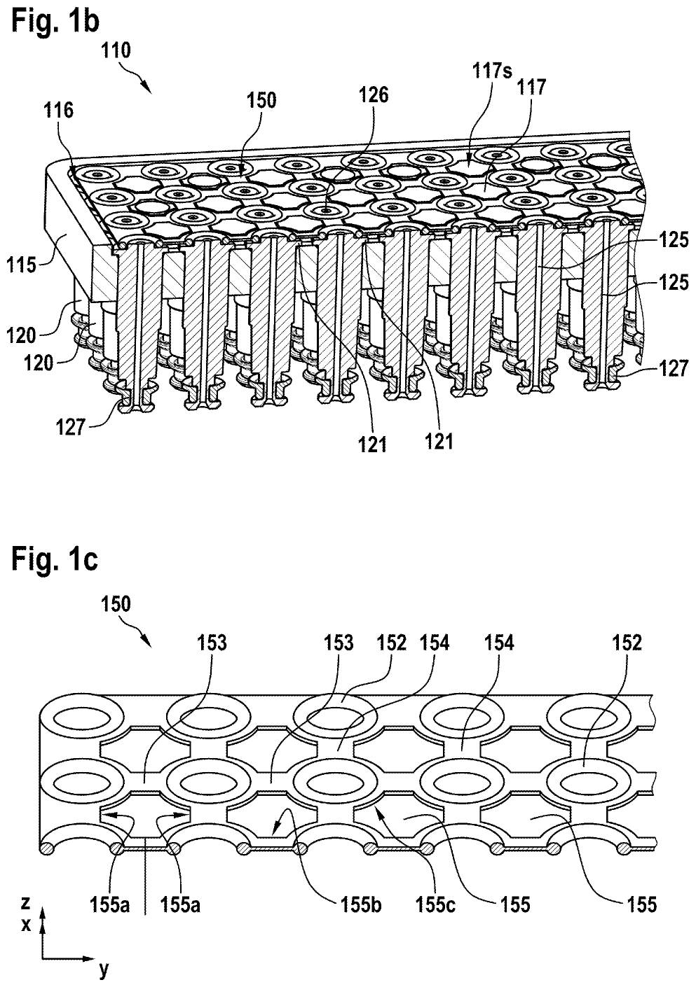

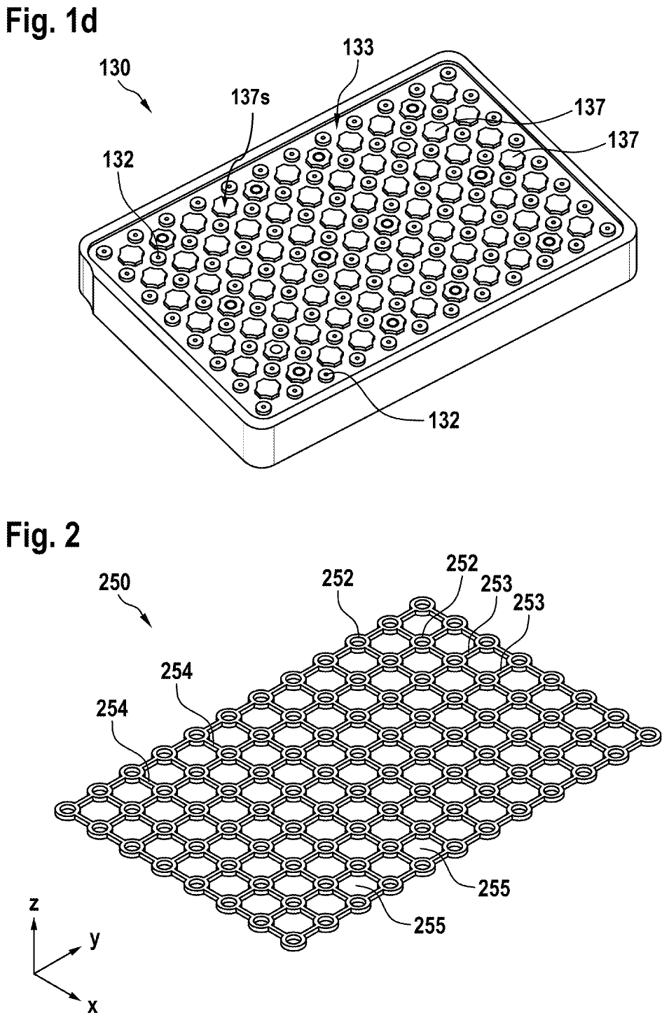

FIG. 1a shows a cross-sectional view of a multichannel head device 100 according to an embodiment of the invention, which forms part of a liquid handling apparatus that may be used in a laboratory environment to dispense liquid via an array of disposable tips that are attachable to individual connectors 120, which form part of a connector block of the device. A cut perspective view of the connector block 110 is shown in FIG. 1b. The connector block comprises a connector plate 115, which in the depicted example comprises apertures for accommodating an array of 12*8 connectors. The connectors 120 have an upper collar 121 that is supported on an upper surface 116 of the connector plate 115, whereby a main body of each connector extends through the connector plate. Each connector is provided with an internal passageway 125 that extends through the connector from a first end to a second end, whereby the first end is defined as the end where an entrance 126 to each internal passageway is located. A second end of each connector is suitably provided with a seal 127 for providing an airtight connection with the internal diameter of a pipetting tip, when the connector block is lowered to pick up an array of tips that are supported on a tray. To provide an airtight seal at the entrance 126 to each connector internal passageway 125, the multichannel head is further provided with a sealing mat 150, which will be described in detail later.

Liquid is aspirated and then dispensed with the aid of a plunger block 130, comprising an array of 12*8 plungers 135 that are displaceable within channels that extend through the plunger block. The internal passageway 125 of each connector 120 is in fluid communication with an opening 132 in each channel of the plunger block that accommodates the corresponding plunger 135. To provide the displacement and generate negative/positive pressure, each plunger 135 is connected to a piston plate 140. The piston plate is moveably coupled to a fixed part of the multichannel head via a first displacement mechanism, driven by a first motor (not shown). In the depicted example, the first displacement mechanism comprises an arrangement of three spindles 145, which are driven in a known manner by a belt and pulley system (generally indicated with reference numeral 147). The depicted device further comprises a second displacement mechanism driven by a second motor 180, for moving an ejection plate 170 downward, relative to the connector plate 115, so as to push off the attached pipetting tips after use.

The multichannel head 100 is preferably equipped with capacitive liquid level detection, so as to enable the aspiration of precise amounts of liquid. The details of the detection system are not relevant. To facilitate the capacitive measurements, the connector block in the depicted embodiment is electrically isolated from the plunger block and the multichannel head is provided with an isolation plate 160 made of an electrically non-conducting material that is arranged between the plunger block 130 and the connector block 110. The isolation plate 160 comprises an array 12*8 of bores 165 which are in fluid communication with the opening 132 of each corresponding channel of the plunger block and with the entrance 126 to the internal passageway 125 of each corresponding connector 120.

In other embodiments, the multichannel head may be equipped with capacitive liquid level detection without the need for an isolation plate 160. In such embodiments, the connector block is directly mounted to the plunger block, such that the internal passageway 125 of each connector is in direct fluid communication with the opening 132 of each corresponding plunger channel. In both cases, a fluid space is created between each plunger channel and a pipetting tip that is attached to a corresponding connector. As will be understood, it is necessary for the fluid space to be sealed in an airtight manner. In the depicted embodiment, comprising the isolation plate 160, this could be achieved via a first plurality of individual O-rings arranged at each interface between the opening 132 to a plunger block channel and the corresponding bore 165 of the isolation plate 160 and a second plurality of individual O-rings arranged at each interface between the internal passageway 125 of a connector 120 and the corresponding bore 165 of the isolation plate. In embodiments without the isolation plate, a first plurality of individual O-rings could be arranged at each interface between the internal passageway 125 of a connector 120 and the opening 132 to the corresponding plunger block channel.

In accordance with the invention, the device is equipped with at least one sealing mat that removes the need for a plurality of individual O-rings, thereby significantly reducing the time needed to assemble the multichannel head device.

In the embodiment depicted in FIG. 1a, the device is equipped with a first and a second sealing mat.

An example of part of a sealing mat 150 that may be used in a multichannel head according to the invention is shown in FIG. 1c. The mat comprises an array of annular sealing elements 152 made of an elastomeric material such as EPDM rubber. The multichannel head device of FIG. 1a has 96 channels and is configured for use in conjunction with a 96-well microplate with a centre-to-centre distance of 9 mm. The sealing mat has eight rows of twelve annular sealing elements 152 with a corresponding centre-to-centre distance of 9.0 mm. Adjacent sealing elements are interconnected by a lattice of linkages which extend in longitudinal direction y and in lateral direction x. Each annular sealing element has a thickness in vertical direction z that is greater than a thickness of the laterally extending linkages 154 and the longitudinally extending linkages 153 of the interconnecting lattice. Furthermore, a cut-out region 155 is formed between two opposing lateral linkages 154 and two opposing longitudinal linkages 153.

Advantageously, the sealing mat may be formed in a moulding process. The linkages 153, 154 of interconnecting lattice may be formed from the same material as the sealing elements 152 or may be formed from a second material. The second material may be a polymer such as polyethylene or polypropylene, which is relatively stiffer.

The cut-out regions 155 reduce the amount of material needed for the interconnecting lattice and, in combination with suitable milling of a receiving surface on which the sealing mat is arranged, enable the contact surface area between opposing surfaces to be increased when the head device is in assembled condition. This will be explained later. In the example depicted in FIG. 1c, each cut-out region has opposing lateral edges 155a and opposing longitudinal edges 155b, which are straight. Between each lateral edge and a neighbouring longitudinal edge, the cut-out region 155 comprises a curved section 155c that corresponds to a part of the interconnecting lattice that surrounds the annular sealing element. Such a geometry minimises the amount of material needed for the lattice. Other geometries are possible. For example, the cut-out region may be circular, oval, or octagonal in shape.

Returning to FIG. 1b, a sealing mat as shown in FIG. 1c is arranged on the upper surface 116 of the connector plate 115. In the depicted example, the annular sealing elements of the mat have a thickness of 1.0 mm and the linkages of the interconnecting lattice have a smaller thickness of e.g. 0.3 mm. The connector block 110 is mounted to the plunger block 130 via the isolation plate 160. Suitably, each of these parts is provided with coaxial connection holes for e.g. a bolted connection, to enable precise positioning of the parts relative to each other. The upper surface 116 of the connector plate is clamped against the underside of the isolation plate 160, so as to compress the annular sealing elements 152 of the mat, which surround the entrance 126 to the internal passageway of each connector 120. Due to the smaller thickness of the interconnecting lattice of the mat, the clamping force required to compress the sealing elements 152 is no greater than would have been needed for 96 individual O-rings, although the assembly time is considerably reduced.

The connector plate is further adapted such that the sealing mat may be precisely located on the upper surface 116. The connector plate comprises protrusions 117 and corresponding recessed portions that are milled into the upper surface. The protrusions are identical in shape to the cut-out regions 155 of the sealing mat and have a flat top surface 117s that is in contact with the underside of the isolation plate 160 when the connector block is bolted to the plunger block. The protrusions 117 may have a “height” relative to the recessed portions of e.g. 0.75 mm. The cut-out regions in the sealing mat enable the top surface 117s of the protrusions to be in contact with the underside of the isolation plate 160. A relatively large contact surface area between these opposing surfaces is advantageous in terms of increasing stability and providing a robust connection interface.

In the depicted example, the isolation plate 160 has a flat underside. In other examples, the underside is milled to comprise recessed portions and protrusions for locating the sealing mat and increasing the contact surface area. The isolation plate also has a flat top side in the depicted example and the underside of the plunger block is adapted to receive a second sealing mat. The second sealing mat is identical to the mat shown in FIG. 1c and as described with reference to FIG. 1b.

A perspective view of the underside of the plunger block is shown in FIG. 1d. The lower surface 133 of the plunger block 130 has been milled to a depth of 0.75 mm so as to create protrusions 137 that are shaped to pass through the cut-out regions 155 of the second sealing mat. The protrusions 137 have a flat surface 137s, which bear against the upper surface of the isolation plate when the head device is in assembled condition. Suitably, the lower surface 133 of the plunger block 130 is further milled such that the openings 132 to each plunger channel are provided in a raised annular portion that will be surrounded by the corresponding annular sealing element 152 of the mat. When the connector block is mounted to the plunger block, the annular sealing elements are compressed to provide an airtight connection between the opening 132 to each plunger channel and the corresponding entrance to each bore 165 in the isolation plate 160. As will be understood, other dimensions are possible for the thickness of the annular sealing elements and the milled depth of the surface on which the sealing mat is arranged. It is also possible for the upper surface of the isolation plate to be milled so as to receive the second sealing mat and the plunger block may have a flat underside.

A further example of a sealing mat that may be used in a multichannel head according to the invention is depicted in FIG. 2. The sealing mat 250 is made from a single sheet of elastomeric material of uniform thickness. The mat in the depicted example comprises an array of 12*8 annular sealing elements 252 which, in use, are compressed to provide an airtight connection between the openings to the plunger block and the corresponding internal passageway 125 of the connectors (in embodiments without an isolation plate), or to provide an airtight connection between the bores 165 in the isolation plate and the corresponding plunger block opening/connector internal passageway.

The annular sealing elements 252 are interconnected by a lattice of linkages that extend in longitudinal direction y and lateral direction x. As before, the interconnecting lattice creates cut-out regions 255 formed between two opposing longitudinal linkages 253 and two opposing lateral linkages 254. Such a sealing mat is suitable for arrangement on the connector block 110 shown in FIG. 1b and on the plunger block 130 shown in FIG. 1d. Advantageously, the size of the cut-out regions is maximized, to minimise the amount of material needed and so that the surface area of the mat which needs to be compressed is minimised. Suitably, the longitudinal linkages 253 have a width in lateral direction x and the lateral linkages 254 have a width in longitudinal direction y that is considerably smaller, e.g. at least 50% smaller, preferably 75% smaller, than an outer diameter of the annular sealing elements 252.

In order to further reduce the clamping force that is required to compress the annular sealing elements, it is also possible to mill the receiving surface on which the mat is arranged such that the linkages are accommodated in portions of the surface which are somewhat deeper relative to portions of the surface on which the annular sealing elements 252 rest.

Thus, the use of a sealing mat in a multichannel head device in accordance with the invention significantly reduces assembly time and enables the device to be assembled with the application of relatively low clamping forces and with robust and stable connection interfaces.

Examples, embodiments or optional features, whether indicated as non-limiting or not, are not to be understood as limiting the invention as claimed. It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

### LIST OF REFERENCES AND ABBREVIATIONS

The following list of references and abbreviations is provided for facilitating the interpretation of the drawings and shall not be construed as limiting the claims.
100 multi-channel pipetting head
110 connector block
115 connector plate
116 upper surface of connector plate
117 shaped protrusion on upper surface of connector plate
117s top surface of protrusion
120 connector
121 upper collar of a connector
125 internal passageway through connector
126 entrance to internal passageway at first end of connector
127 ring seal at second end of connector
130 plunger block
132 opening in channel of plunger block
133 lower surface of plunger block
135 plunger
137 shaped protrusion on lower surface of plunger block
137s underside of shaped protrusion
140 piston plate of multichannel pipetting head
145 spindle to which piston plate is moveably coupled
147 belt and pulley arrangement for driving spindles
150, 250 sealing mat
152, 252 annular sealing element
153, 253 longitudinal linkage that interconnects adjacent sealing elements in longitudinal direction (y)
154, 254 lateral linkage that interconnects adjacent sealing elements in lateral direction (x)
155, 255 cut-out region between two opposing lateral linkages and two opposing longitudinal linkages
155a lateral edge of cut-out region
155b longitudinal edge of cut-out regions
155c curved section of cut-out region
160 isolation plate
165 bore through isolation plate
170 ejector plate
180 motor for driving displacement mechanism to which ejection plate is moveably coupled
x lateral direction
y longitudinal direction
z vertical direction

1-10. (canceled)

11. A multichannel head of a pipetting device for aspirating and dispensing a liquid via a plurality of pipetting tips, the multichannel head comprising:
a connector block comprising an array of m*n connectors, whereby each connector comprises an internal passageway that is fluidically connectable to a pipetting tip, and
a plunger block comprising a corresponding array of m*n channels, whereby each channel accommodates a plunger and has an opening that is fluidically connected to the internal passageway of a corresponding connector;
wherein the multichannel head further comprises at least one sealing mat arranged between the connector block and the plunger block, which comprises a corresponding array of m*n annular sealing elements made of an elastomeric material, for sealing the fluidic connection between the internal passageway of each connector and each opening of the corresponding channel of the plunger block, wherein the annular sealing elements are interconnected by a lattice of linkages that extend in lateral direction (x) and in longitudinal direction (y), such that a cut-out region is formed between two opposing lateral linkages and two opposing longitudinal linkages, and wherein:
the at least one sealing mat is arranged on a corresponding at least one receiving surface, which is provided with protrusions that are shaped to pass through the cut-out regions of the at least one sealing mat, such that recessed portions are created in the receiving surface which locate the sealing mat.

12. The multichannel head of claim 11, wherein the annular sealing elements of the at least one sealing mat are compressed against an opposing surface and wherein portions of said opposing surface are in contact with a surface of each protrusion.

13. The multichannel head of claim 11, wherein the annular sealing elements of the at least one sealing mat have a thickness in vertical direction (z) which is greater than a thickness of the linkages of the interconnecting lattice.

14. The multichannel head of claim 13, wherein the linkages of the interconnecting lattice are made of a second material, different from the elastomeric material of the annular sealing elements.

15. The multichannel head of claim 11, wherein the at least one sealing mat is of uniform thickness in vertical direction (z) and is formed of a single piece.

16. The multichannel head of claim 14, wherein the at least one receiving surface on which the at least one sealing mat is arranged comprises first recessed portions for accommodating the linkages and second recessed portions for accommodating the annular sealing elements, and wherein the first recessed portions are relatively deeper than the second recessed portions.

17. The multichannel head of claim 11, wherein the plunger block is directly mounted to the connector block, and wherein the receiving surface on which the at least one sealing mat is arranged is formed by one of a lower surface of the plunger block and an upper surface of a connection plate in which the connectors are provided.

18. The multichannel head of claim 11, further comprising an isolation plate made of an electrically non-conducting material, which is arranged between the connector block and the plunger block, wherein the isolation plate comprises a corresponding array of m*n bores in fluidic connection with the opening of the corresponding channel in the plunger block and with the internal passageway of the corresponding connector, and wherein:
the at least one sealing mat comprises a first sealing mat arranged between the connector block and the isolation plate and a second sealing mat arranged between the isolation plate and the plunger block; and
the at least one corresponding receiving surface comprises a first receiving surface for the first sealing mat and a second receiving surface for the second sealing mat.

19. The multichannel head of claim 18, wherein:
the first receiving surface is formed by one of a lower surface of the isolation plate and the upper surface of the connector plate; and
the second receiving surface is formed by one of an upper surface of the isolation plate and the lower surface of the plunger block.

20. The multichannel head of claim 11 wherein:
m=12 and n=8; or
m=24 and n=16; or
m=48 and n=32; or
m=6 and n=4.
